(19) United States
(12) Patent Application Publication
(10) Pub. No.: US 2021/0059456 A1
(43) Pub. Date: Mar. 4, 2021

(54) Garage parcel box

(71) Applicant: Nel R Fontanilla, San Jose, CA (US)

(72) Inventor: Nel R Fontanilla, San Jose, CA (US)

(21) Appl. No.: 16/602,236

(22) Filed: Sep. 3, 2019

(51) Int. Cl. A47G 29/16; A47G 29/30; A47G 29/14

(52) U.S. Cl. CPC A47G 29/16; A47G 29/30; A47G 2029/148; E05Y 2900/106; A47G 2029/143; A47G 29/141

(57) ABSTRACT

A Parcel Box that is mounted on the garage door of a residential home for package and mail delivery comprises an outer box having a front door with a lock and an inner box having a back door with a lock, an inner box that allows the parcel box to be extended in volume capacity to accommodate varying sizes of packages, a barcode reader for scanning a barcode that is affixed on the package for unlocking the front door, a processor that communicates with the barcode reader to determine that the barcode matches one of the stored codes in the processor's storage and the processor sends a command to unlock the front door then the processor communicates with the wireless network that sends a message to the user's cell phone that a package is delivered inside the parcel box, a security camera that records the activity around the parcel box, a security lights for illuminating the driveway during night time, and a slot for receiving mails.

### FIELD OF INVENTION

This invention relates generally to a parcel box and more particularly, to a garage parcel box mounted on the garage door of a residential home for package and mail delivery. This garage parcel box is a smart parcel box having, unlocking mechanism using barcode, weight sensor, motion-controlled video camera, motion-controlled security lights and wireless network.

### BACKGROUND OF THE INVENTION

Most homeowners have had a package stolen from their front porch or mailbox. Some people make sure they are at home to receive their package and some people will leave from work early or work from home if they are expecting a delivery. Online shopping is prevalent that during holiday seasons, most people expects to have package delivery numerous times. In many instances the ordered items are delivered and simply placed right to your doorstep.

Lock boxes that are permanently mounted to fixed object are known and used in single family homes. Most of the time, such a permanently mounted lock box may not have space in the front porch and an obstruction.

### SUMMARY OF THE INVENTION

This invention provides a parcel box that is mounted on the garage door of a residential home for package and mail delivery. This invention provides an electronic controlling mechanism of opening the box by using a barcode. A processor unit inside the parcel box is the brain of the control system that communicates to input and output peripherals, such as, barcode reader, weight sensor, security camera, security lights and wireless network.

The delivery person positions the barcode sticker that is affixed on the package near the barcode reader window and the bar code reader scans the barcode and if the code matches what is stored in the processor's storage, the processor sends a command to the electronic lock assembly to unlock and open the front door of the parcel box.

This parcel box also provides a monitoring feature that sends messages to the user's cell phone. The processor monitors the weight sensor device that detects the presence of a package inside the parcel box and then connects to the wireless network and sends messages to the user's cell phone that a package is delivered.

This parcel box also provides a motion-controlled security video camera that records the activities around the garage driveway.

This parcel box also provides a motion-controlled security lights for illuminating the garage driveway during nighttime.

In a preferred embodiment, the current invention provides a smart parcel box, which include a box body having a door with a lock; a processor that controls the multiple units inside the parcel box, such as, a barcode scanner unit for scanning a barcode so as to unlock the box and thus open it; a motion-controlled video camera unit that records the circumstance around the box before and after the box opening; a motion-controlled security lights unit that turns on at night where the lights intensity is at low as a default setting and at high setting when a presence of moving person or object and stays high for some period of time then revert to low setting; an internet network unit for communicating with the remote system for sending messages to the user.

Another aspect of this invention, it is provided a parcel box, which including a slot for receiving mail; an outer box having a front door with lock; an inner box that is movable by sliding in or out of the outer box that allows for expanding in volume capacity of the parcel box to accommodate larger package and contracting in volume capacity of the parcel box to accommodate smaller package and for space saving inside the garage; a second door attached at the back of the inner box for the user to retrieve the package from inside the garage; a light indicator that is visible only from inside of the garage to indicate the presence of package inside the parcel box.

These and other features, aspects and advantages of the present invention will become better understood with reference to the following drawings, description and claims.

### BRIEF DESCRIPTION OF THE DRAWINGS

FIG. 1 is a perspective view from the outside of the garage illustrating the parcel box attached on the garage door panels.

FIG. 2 is a perspective view from the inside of the garage illustrating the parcel box attached on the garage door panels.

FIG. 3 is a perspective view from the inside of the garage illustrating the hinges for the parcel box attached on the garage door panels.

FIG. 4 is a perspective view of the parcel box illustrating the front door is in the open position and the inner box is in the expanded position.

FIG. 5 is a perspective view of the parcel box illustrating the front door is in the open position and the inner box is in the contracted position.

FIG. 6 is a perspective view of the parcel box illustrating the front door is in the close position and the inner box is in the contracted position.

FIG. 7 is a front view of the parcel box illustrating the front door is in the close position.

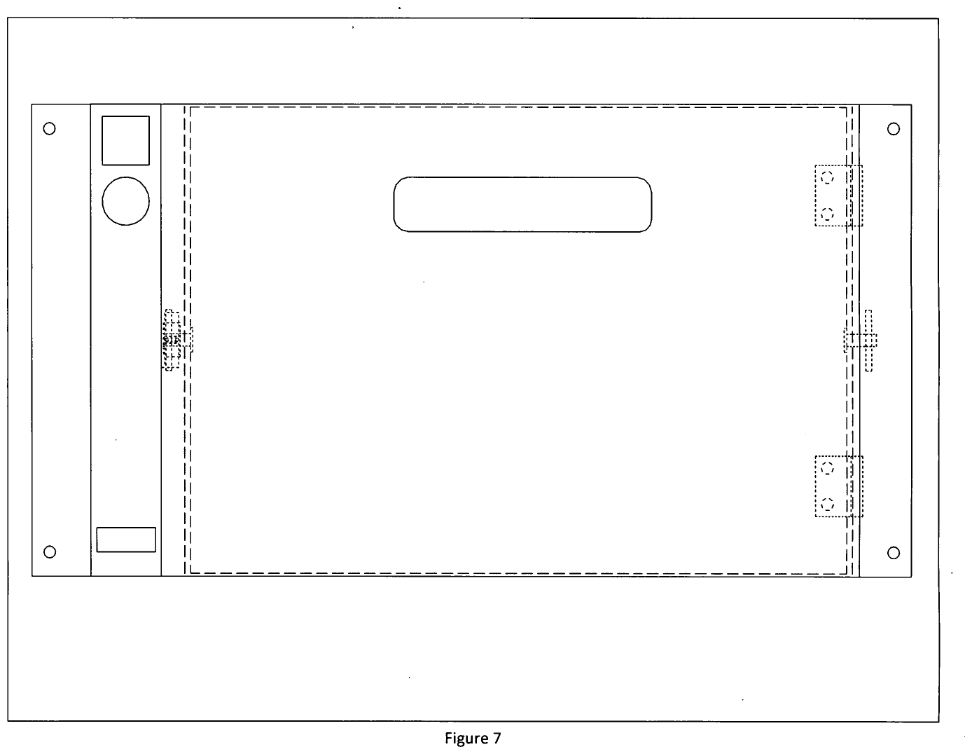

FIG. 8 is a side view of the parcel box illustrating the inner box in the contracted position and the front door is in the close position.

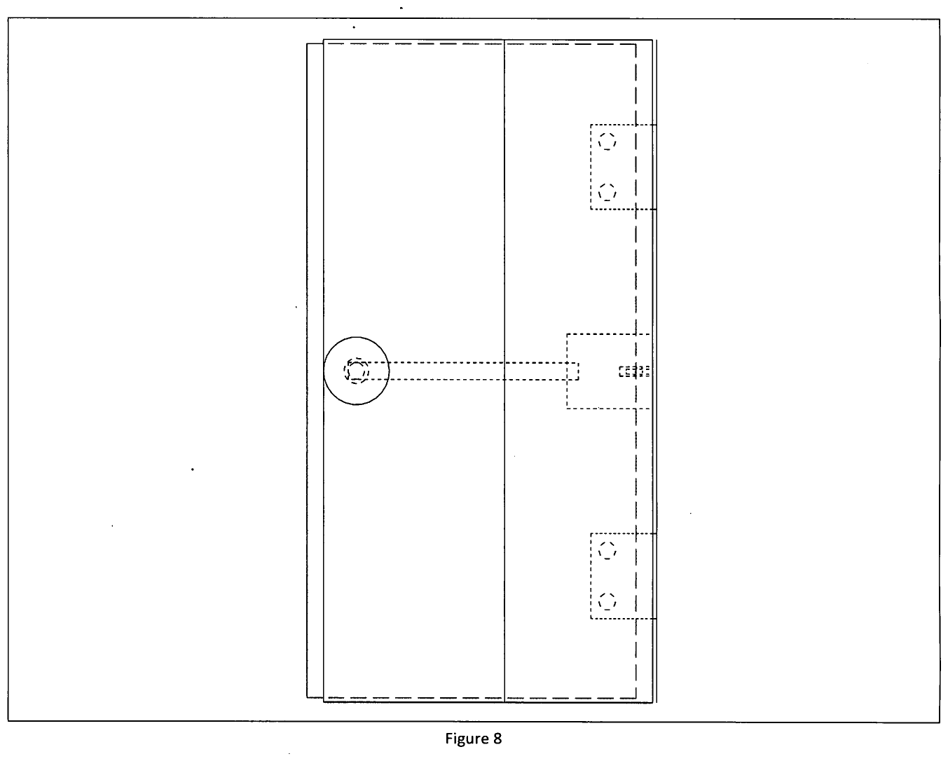

### DETAILED DESCRIPTION OF THE INVENTION

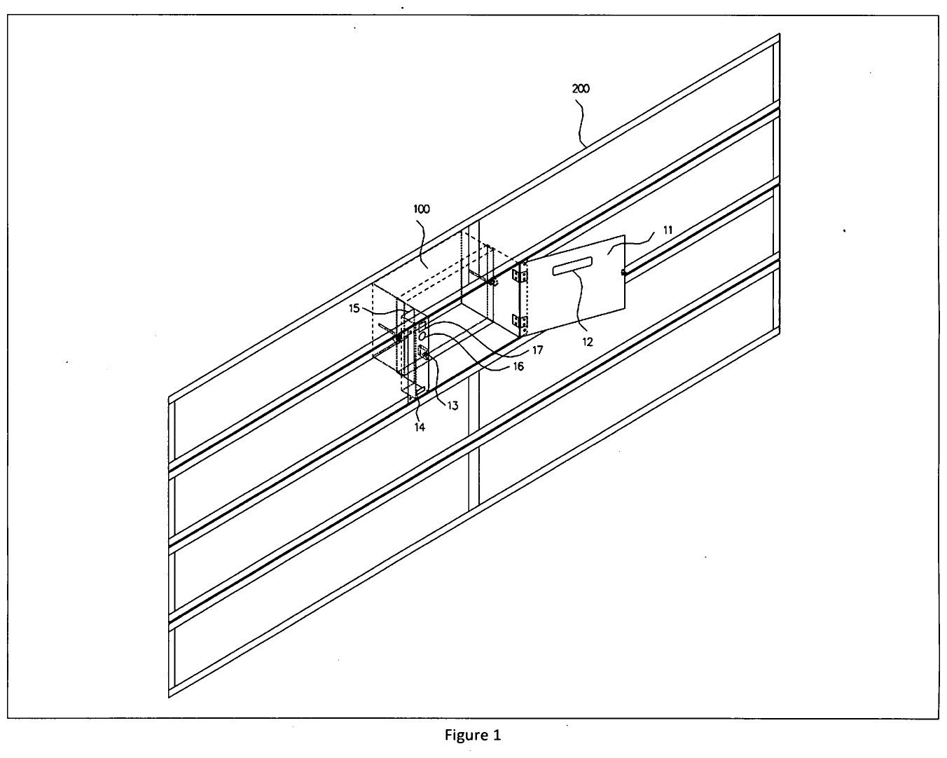

Reference will now be made in detail to the preferred embodiments of the invention. One embodiment of the present invention is illustrated in FIG. 1 showing the parcel box 100 installed on the garage door panels 200 with the outer box front door 11 in the open position and a slot 12 on the front door for receiving mails. When the barcode that is affixed on the package is positioned near the barcode scanner 14 on the parcel box, the barcode scanner scans the barcode and if found a match to the stored data from the processor's storage, the electronic lock 13 opens. The processor which is located inside the electronic compartment box 15 then reads the weight sensor to determine that the package is inside the parcel box and closes the outer box front door 11. The processor then sends a message via the wireless network to the user's cell phone that a package is delivered inside the parcel box. The processor controls the camera 16 recordings before and after the parcel box is opened. The user after receiving the message that a package is delivered inside the parcel box, may view the recordings on the user's cell phone. During at nighttime, the motion-controlled security lights 17 turns on to illuminate the driveway.

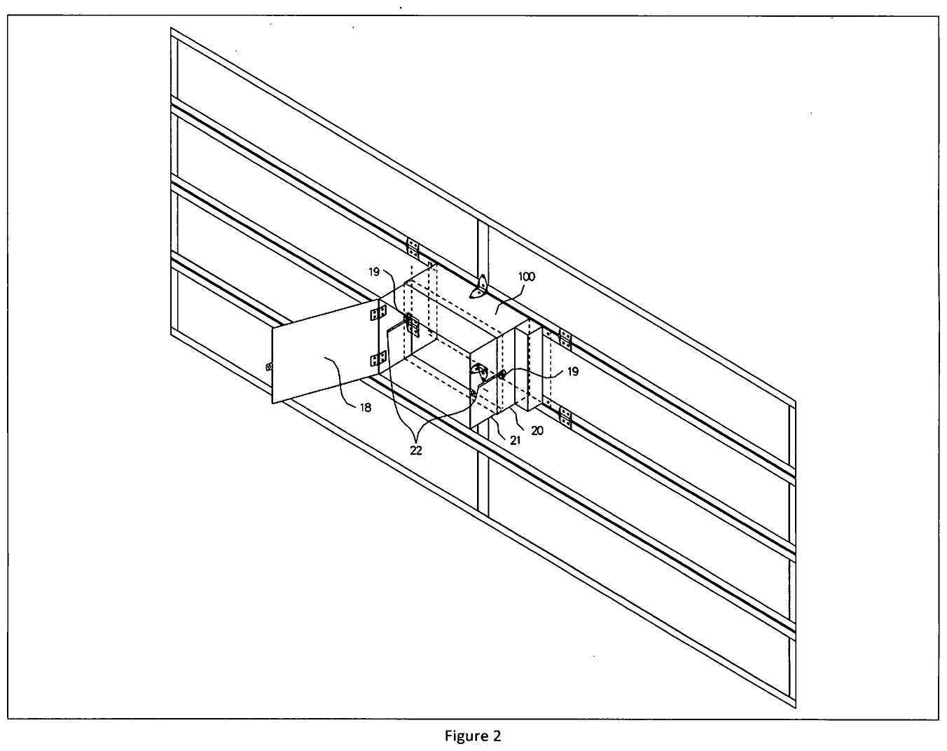

FIG. 2 illustrates the back door 18 of the parcel box in the open position and the inner box 21 in the expanded position. There are two knobs 19 that allow the inner box to be expanded or contracted to accommodate varying package sizes. The knobs are rotated counterclockwise to loosen up the grip between the outer box 20 of the parcel box and the movable inner box of the parcel box. The expandable section of the parcel box, which is the inner box, moves along the two slots 22 on the sides of the inner box. When the desired expanded position is reached, the knobs are rotated clockwise to tighten the grip between the inner box and outer box to keep the inner box in place.

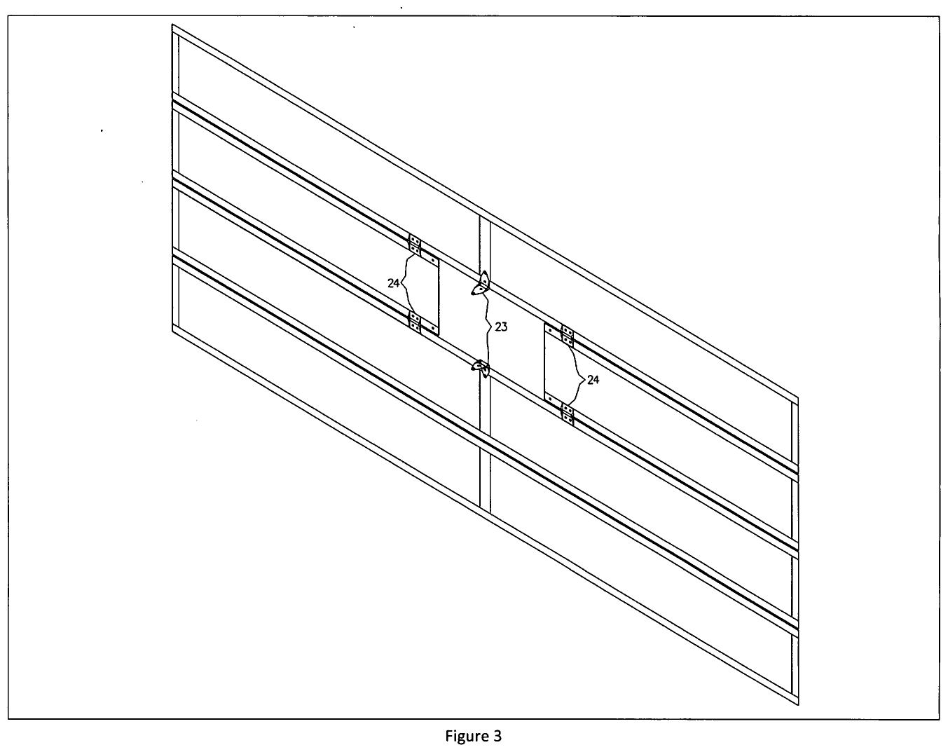

FIG. 3 illustrates the two hinges 23 that are attached to the parcel box to hold the parcel box in place. There are four hinges 24 that are attached to the garage door panels to keep the panels in place.

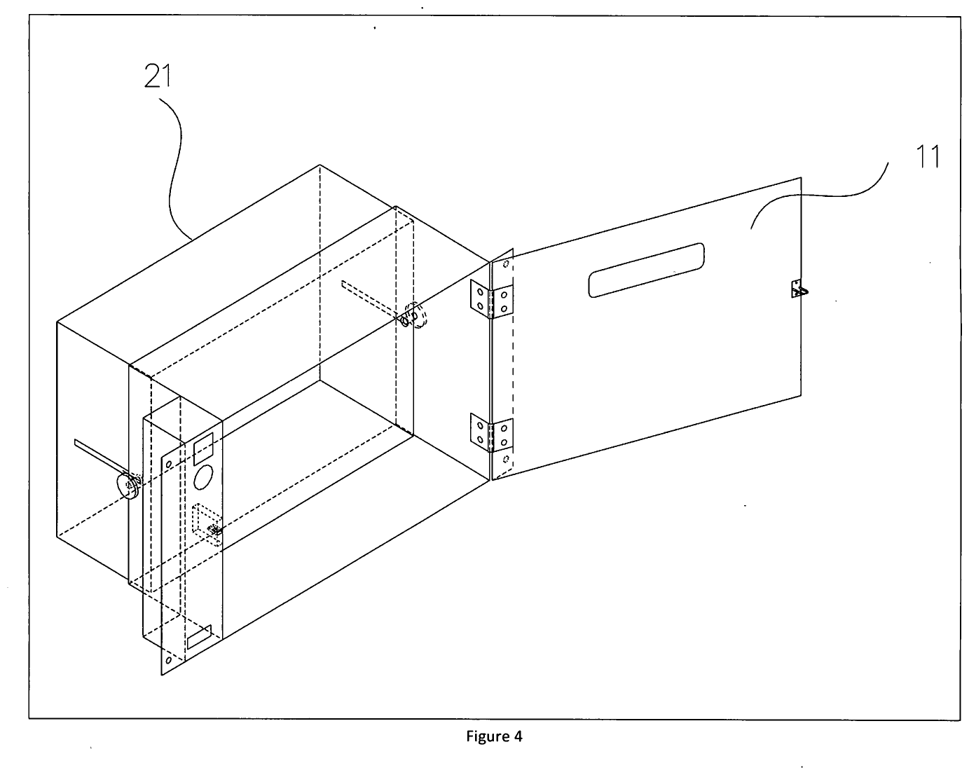

FIG. 4 illustrates the parcel box not installed on the garage door. The front door 11 is in the open position and the inner box 21 is in the expanded position.

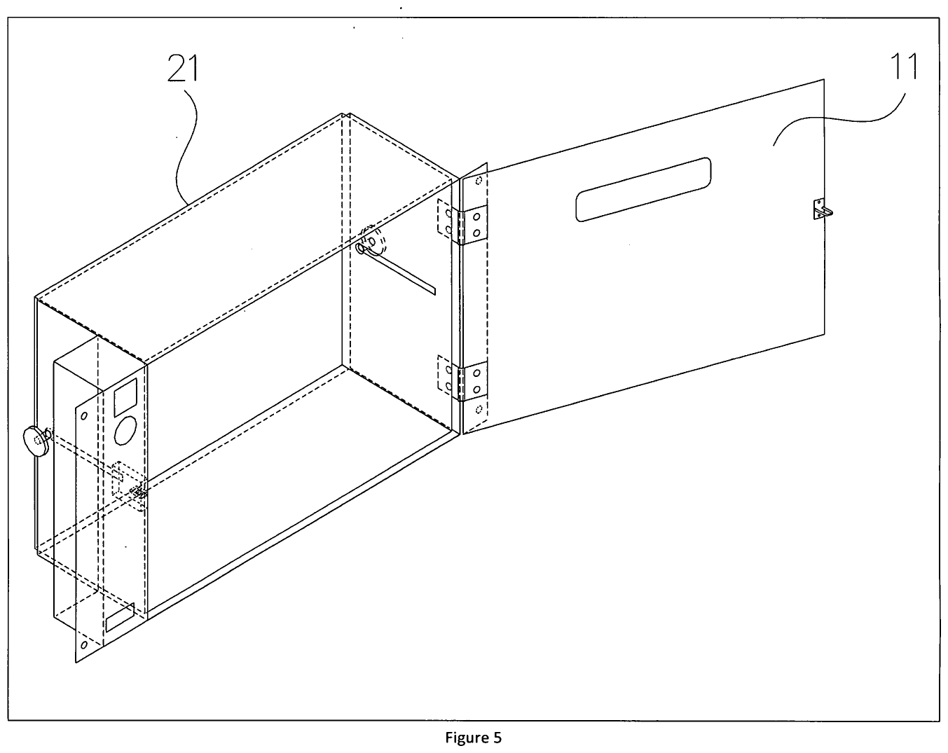

FIG. 5 illustrates the parcel box not installed on the garage door. The front door 11 is in the open position and the inner box 21 is in the contracted position.

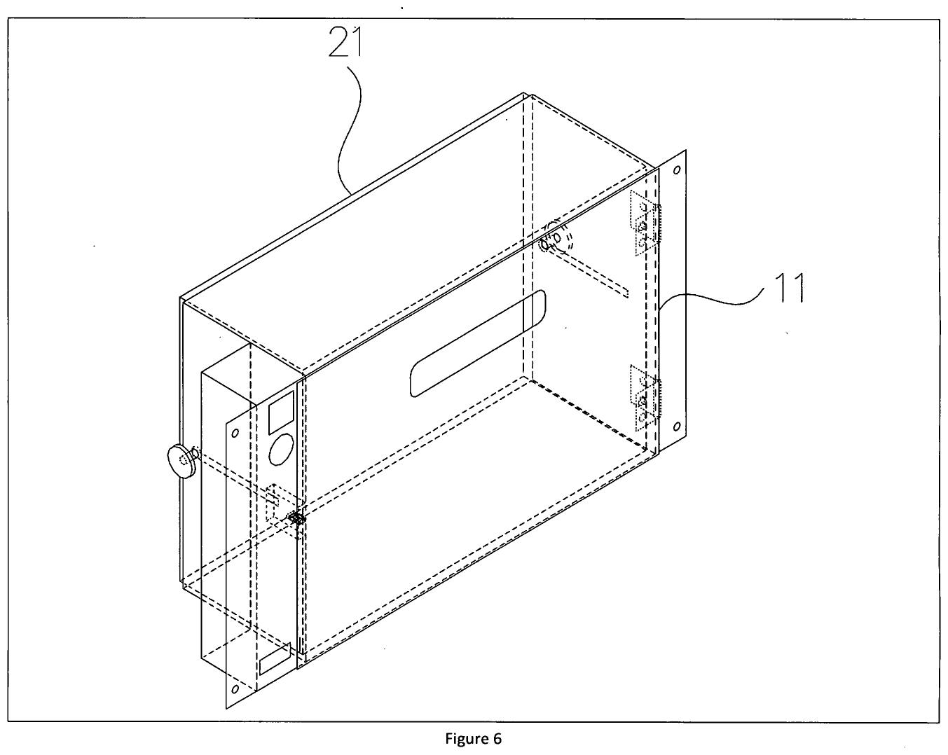

FIG. 6 illustrates the parcel box not installed on the garage door. The front door 11 is in the close position and the inner box 21 is in the contracted position.

What is claimed is:

1. A Parcel Box that is mounted on the garage door of a residential home for package and mail delivery. Said parcel box comprising:
An outer box having a front door with a lock and inner box having a back door with a lock;
an inner box that allows the parcel box to be extended in volume capacity to accommodate varying sizes of parcels;
a barcode reader for scanning the affixed barcode on the package for unlocking the front door;
a processor configured to: communicate with the barcode reader to determine that the barcode matches one of the stored codes in the processor's storage and the processor issue a command to unlock the electronic lock and opens the front door, communicate with the wireless network that sends a message to the user's cell phone that a package is delivered inside the parcel box, read the sensor that detects the presence of a parcel inside the parcel box and sends a command to close the front door.
a camera that records the activity before and after the parcel box is opened,

2. The parcel box of claim 1, further comprising: a motion-controlled security lights for illuminating the driveway during nighttime.

3. The parcel box of claim 1, further comprising a slot on the front door for receiving mails.

4. The parcel box of claim 1, further comprising knobs that allows the parcel box to be expanded or contracted to a varying volume capacity of the parcel box.

5. The parcel box of claim 1, further comprising multiple hinges that are attached to the parcel box and to the garage door panels to keep the parcel box in place.

6. The parcel box of claim 1, further comprising multiple hinges that are attached to the garage panels to support the panels in place.

7. The parcel box of claim 1, further comprising a compartment that stores the electronic control devices.

8. The parcel box of claim 1, further comprising a light indicator that is visible only from inside of the garage to indicate the presence of package inside the parcel box.

9. A Parcel Box that is mounted on the front door of a residential home for package and mail delivery. Said parcel box comprising:
An outer box having a front door with a lock and inner box having a back door with a lock;
an inner box that allows the parcel box to be extended in volume capacity to accommodate varying sizes of parcels;
a barcode reader for scanning the affixed barcode on the package for unlocking the front door;
a processor configured to: communicate with the barcode reader to determine that the barcode matches one of the stored codes in the processor's storage and the processor issue a command to unlock the electronic lock and opens the front door, communicate with the wireless network that sends a message to the user's cell phone that a package is delivered inside the parcel box, read the sensor that detects the presence of a parcel inside the parcel box and send a command to close the front door.
a camera that records the activity before and after the parcel box is opened,

10. The parcel box of claim 8, further comprising: a motion-controlled security lights for illuminating the front porch during nighttime.

11. The parcel box of claim 8, further comprising a slot on the front door for receiving mails.

12. The parcel box of claim 8, further comprising knobs that allows the parcel box to be expanded or contracted to a varying volume capacity of the parcel box.
